(19) United States
(12) Patent Application Publication
(10) Pub. No.: US 2016/0234342 A1
(43) Pub. Date: Aug. 11, 2016

(54) Enterprise Data Processing Architecture with Distributed Intelligence

(71) Applicants: Stephen Oonk, Simi Valley, CA (US); Francisco J. Maldonado, Simi Valley, CA (US)

(72) Inventors: Stephen Oonk, Simi Valley, CA (US); Francisco J. Maldonado, Simi Valley, CA (US)

(21) Appl. No.: 14/619,796

(22) Filed: Feb. 11, 2015

(51) Int. Cl. H04L 29/06

(52) U.S. Cl. CPC H04L 67/42

(57) ABSTRACT

The architecture design and functional operation of an enterprise data processing system with distributed intelligence capable of monitoring sensor networked systems and processing large sets of data as required by the application is disclosed in this invention. The system is based on smart sensor/actuator nodes, local processing units, a server, and clients. Smart nodes interface with transducers for conducting data acquisition or control and consist of a small processor, a communications module, and transducer interfacing circuitry. The processor includes instructions to execute commands and may contain small-form factor processing algorithms. Sensor and processed data is then transmitted to the local processing units which perform higher level processing and contain functions for managing the nodes. The local processing units have small databases that are updated with the status of the monitored system. These devices then communicate with a server based on commands and automated event messages. The server consists of a database for storing and organizing data. The database can be remotely accessed from a client, which may be a smartphone or similar device. These components may be connected with either wired or wireless networks, and information ubiquity is ensured from an Internet portal. Additionally, Intelligent Software Elements may be designed at the higher system levels and then transferred and embedded at the lower level distributed processing platforms.

### CROSS REFERENCE OF RELATED APPLICATION

This is a regular application of a provisional application having an application No. 61/939,139 and a filing date of Feb. 12, 2014.

### BACKGROUND OF THE PRESENT INVENTION

1. Field of Invention

This present invention provides an enterprise data processing architecture with distributed intelligence that can be applied to large networked systems, where examples include environmental sensing networks, supply chain and depot management systems, and the monitoring of critical assets at manufacturing facilities or industrial plants. The technology is related to the field of information technology (IT), where an Enterprise infrastructure based on a central server and set of remote clients with wired or wireless communications enables the transfer of data relating to the monitored system. The server consists of a graphical user application and database for storing data in an organized way. The client, which may be a mobile device, then contains a graphical user application for interacting with the server's database. The invention is also related to the field of artificial intelligence (AI) for data processing, since intelligent software elements (ISE) can be designed and instantiated at multiple levels for performing a variety of tasks such as pattern recognition, functional approximation, etc. Finally, the technology is related to the field of smart sensors, where distributed processing nodes interface directly with sets of transducers to conduct data acquisition but also contain external communication interfaces and embedded processing capabilities such as for storing sensor specifications data and executing small-form factor data processing. This present invention relates to the system architecture of the enterprise data processing system.

2. Description of Related Arts

An enterprise architecture for a widely distributed data processing system is a key innovation of the present invention. There are some currently related but different technologies within both the research community and commercial sector. The paper by Lowe, A., “Data Awareness from ATE”, describes a data infrastructure using relational database technology for efficiently observing, analyzing, and controlling automated test and manufacturing processes. Web services are briefly mentioned as a way to create data awareness, but the database is the main aspect of the paper. The Bluetick Remote Monitoring and Control System (RMC) is a current commercial product that is similar in the sense that it integrates data from a very large sensor network, transports it over cellular or satellite networks, and then securely presents the results to an analysis team. The goals of that product are to optimize oil and gas production, enhance environmental compliance, mitigate safety risks, and free staff for preventative maintenance, among others. However, the current invention is different from that technology as it addresses functionality for providing distributed intelligence, adheres to smart sensor standards, is compatible with the newest mobile devices, and includes flexibility for wired as well as wireless communications. The paper by Xian, H. and Madhavan, K. “Sensor World: Unified Touch Based Access to Sensors Worldwide”, is yet another example of a related technology that describes the SensorWorld project which analyzes data from sensors worldwide based on service and data layers.

Another core technology is that of a distributed smart sensor network for data processing over expansive areas. Smart sensor networks have seen significant growth in recent years as embedded technologies have advanced. According to Global Industry Analysts, Inc. the global market for smart sensors will reach $6.7 Billion by 2017. Strong growth is expected for MEMS sensors and smart sensors with bus capabilities and embedded processing. In a study conducted by the Engineering Technology Department and NASA Stennis Space Center, 32 smart sensor vendors were identified, where vendors with IEEE 1451 compatible sensor systems/platforms include: Honeywell, Max Stream, National Instruments, Oceana Sensors, S3C Incorporation, Smart Sensors Systems, Talon Inc., and ZMD. A paper in by F. Barrero, et. al., detailing the “VisioWay” product is one example of an application of the standard, in that case related to Intelligent Transportation Systems for road-traffic monitoring.

There exist several examples in the patent literature of networked monitoring systems with remote sensors. The patent US 20130094430A1 “System and Method to Monitor and Control Remote Sensors and Equipment” details an invention consisting of a processor, memory, two transceivers, and plurality of wired or wireless ports for a self-sustaining, autonomous, monitoring, reporting, and control system. Another example is US 20070040647A1 “System for Monitoring and Control of Transport Containers” which teaches us of a system for remote monitoring and controlling of a container based on a wireless or wired network with a local station having access points in the vicinity of the location of the containers and a remote central station connected to the Internet. The U.S. Pat. No. 8,594,866B1 “Remote Sensing and Determination of Tactical Ship Readiness” overviews an apparatus consisting of a sensor system, computer system connect to the sensor system, satellite transceiver, and automatic identification system for monitoring of vessel performance and environmental data. Although these patents are all related to the present invention, they do not anticipate aspects pertaining to distributed processing from the sensors all the way to the server, adherence to the newest smart sensor standards, and the distribution of artificial intelligence capabilities using intelligent software elements.

Applications for such a data processing architecture include: (1) supply chain and depot management; (2) large heating and cooling systems in commercial facilities; (3) auxiliary and support systems in power plants; (4) industrial processing facilities; (5) manufacturing plants; (6) oil field extraction and refinement systems, among others. The wireless distributed processing capabilities are relevant to many areas such as scientific data acquisition, surveillance, system control, environmental monitoring, etc.

### SUMMARY OF THE PRESENT INVENTION

The main objective of the present invention is to provide an enterprise data processing architecture with distributed intelligence. Such a system shall be capable of monitoring large sensor network systems, processing data as required by the application, storing and organizing acquired and processed data, and presenting the said data to users in a flexible way over local network or Internet connections.

Another objective of the present invention is to provide a wireless infrastructure with information ubiquity and web services. A client-server framework is utilized based on a web service oriented architecture where the clients are the origin of request objects and handler of response objects and the server is the origin of response objects and handler of request objects. The physical connection between the two can be a wireless local area network (WLAN) or a network with Internet connectivity, hence ensuring for information ubiquity. One or multiple wireless personal area networks (WPAN) should then be available for communicating with the widely distributed lower-level elements of the infrastructure comprised of smart sensor/actuator nodes and local processing units.

Another objective of the present invention is to provide compliance with current smart sensor and related standards. In particular, the IEEE 1451.0 standards for smart sensors and actuators specify a set of commands, operating modes, and details regarding the implementation of Transducer Interface Modules (TIM) which serve as smart sensor/actuator nodes, and Network Capable Application Processors (NCAP) which act as local processing units within the context of the present invention.

Another objective of the present invention is to provide an architecture for the distribution of intelligence in the form of intelligent software elements (ISE). In this type of framework, a relatively powerful computational platform performs high level design of an artificial neural network(s) (ANN) with an inference kernel. Capabilities of this kernel include designing neural networks with supervised, unsupervised, and hybrid learning, and neural network optimization based on pseudogenetic algorithms. Then, the networks acting as ISEs can be executed either locally (for system and subsystem level processing) or embedded in distributed processing units (for component level processing).

Another objective of the present invention is to leverage the proliferation of state-of-the-art mobile devices including smartphones and tablets for conducting remote data analysis operations. This is achieved based on an Internet portal, where with proper authentication and security implementations, users are able to access and manipulate the enterprise data processing system's server database using commands and a query system.

Accordingly, in order to achieve the above mentioned objectives, an enterprise data processing architecture with distributed intelligence is disclosed comprising:

smart sensor/actuator nodes, acting as TIMs in the IEEE 1451.0 context, that interface with one or more transducers to perform data acquisition or control, contain embedded processing for command execution, local data processing, and the storing of Transducer Electronic Data Sheets (TEDS), and that have communication modules;

one or multiple local processing units, acting as NCAPs in the IEEE 1451.0 context, that interface with networks of smart sensor nodes (at the low level) and a server (at the high level) based on wired and/or wireless communications, and that contain the capabilities for command execution and data processing, include local databases, and enable integration into a user's custom applications based on a standardized Application Programming Interface (API);

a server that interfaces with local processing units and sets of remote clients and that contains a graphical user interface (GUI) for user interaction with the data processing system and a relational database for storing relevant data that can be updated by the NCAP (based on automated event messages), local users, or remote clients;

a set of clients, which may be any type of computational platform with web application access such as mobile devices including smartphones, tablets, or laptops, that interact with the server based on a local wireless connection or remotely via an Internet portal for viewing and managing the status of the data processing system based on access to the server's database; and

a distributed intelligence framework where intelligent software elements may be designed (i.e. trained) in platforms with sufficient processing capability (the server, and even clients and/or NCAPs depending on the particular hardware that is used) and then transferred to distributed computational platforms (smart sensor/actuator nodes) for local execution of the learned functions (e.g. pattern recognition and function approximation).

Still further objects and advantages will become apparent from a consideration of the ensuing description and drawings.

These and other objectives, features, and advantages of the invention will become apparent from the following description, drawings, and appended claims.

### BRIEF DESCRIPTION OF THE DRAWINGS

FIG. 1 depicts the overall system architecture involving transducers, smart nodes, a local processing unit with a coordinator, centralized server, Internet portal, and clients. Wireless connections are dashed lines and wired connections are solid lines.

FIG. 2 is a block diagram of the internal components included in both the smart nodes acting as TIMs and the local processing units acting as NCAPs.

FIG. 3 includes a table containing the commands, separated into seven main categories, that guide the TIM and NCAP communication software layer.

FIG. 4 is a block diagram of the internal components embedded in the local processing units as they pertain to the local database, status protocol flag, and registers.

FIG. 5 includes a table containing the status bits and their descriptions that are included in both the NCAP's status register and status mask register.

FIG. 6 is a block diagram depicting the activation of the service request bit for sending error notifications based on the content of the NCAP registers.

FIG. 7 includes a table with the definition of a generic event record table for the local NCAP database. Any number of these types of tables may be defined for certain events pertaining to the data processing and analysis application.

FIG. 8 contains a flow diagram describing the primary states and associated transitions pertaining to the NCAP's operation.

FIG. 9 includes a table containing the commands, separated into three main categories, that guide the NCAP and server communication software layer.

FIG. 10 depicts the bytes used in the data packets at the software layer for the server and NCAP communication. The top is the format from the server to the NCAP; the middle is the format of the entire packet; and the bottom is the reply format to the server.

FIG. 11 is a block diagram representing the server (top rectangle) and client (bottom rectangle) internal blocks and methods for connection.

FIG. 12 is a block diagram representing the query service module (QSM) of the client-server communication framework.

FIG. 13 depicts the distributed intelligence scheme where intelligent software elements can be designed with an inference kernel and embedded in various platforms.

FIG. 14 depicts the structure of the command for transmitting network weights that enable deploying intelligent software elements in distributed embedded systems.

### DETAILED DESCRIPTION OF THE PREFERRED EMBODIMENT

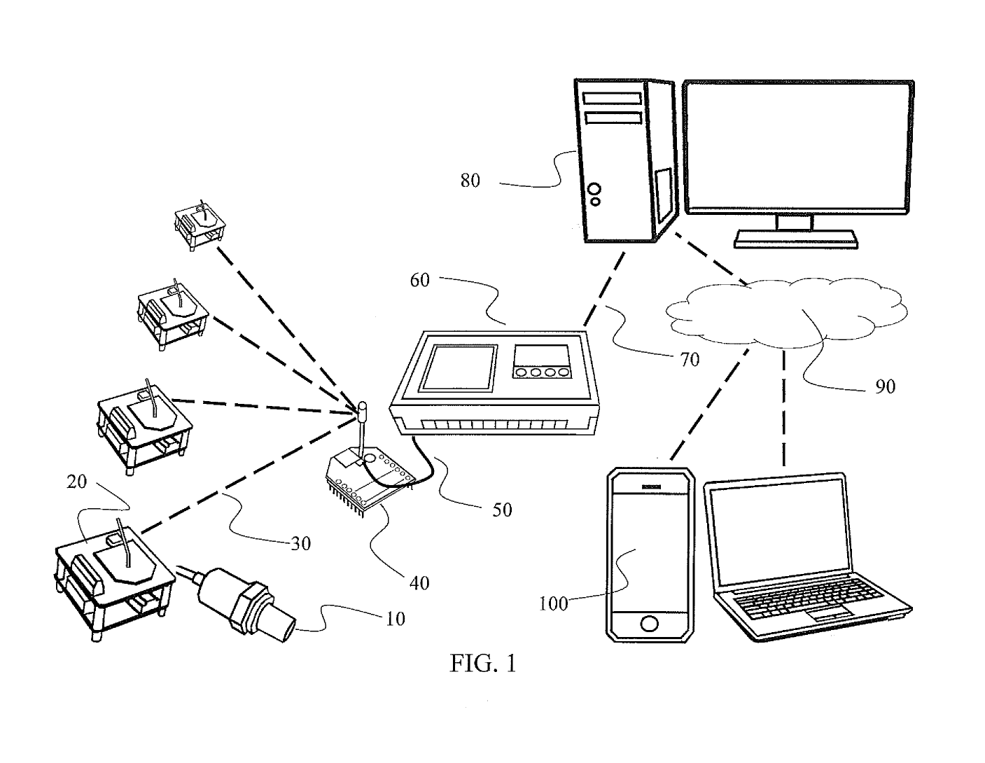

Referring to FIG. 1, the high-level architecture of the enterprise based data processing system according to a preferred embodiment of the present invention is illustrated which consists of transducer sets 10 monitoring key quantities relating to a physical system of interest that are connected to smart sensor/actuator nodes 20. Sensor data, processed results, control instructions, and commands/replies are transmitted over a wired or wireless communication layer 30 between these smart nodes and one or more coordinators 40. An ideal wireless option at this layer is a low power protocol such as ZigBee, although wired serial (RS-232) connections can be established as well. Each coordinator module is then connected over a RS-232 or USB link 50 to a local processing unit 60 that performs supervisory actions, data processing, and regional data aggregation. Data from these local processing units are then transmitted to a centralized server 80 over either a wired link based on RS-232 or Ethernet cables, or a wireless link based on a wireless local area network (WLAN) utilizing TCP/IP sockets 70. The server enables for user management of the entire system with a graphical user interface (GUI) and contains a relational database for organizing the system and configuration data. The server also contains an inference kernel for designing and optimizing artificial neural networks (ANN) and transferring them to embedded systems (e.g. clients, local processing units, and smart nodes). Remote access to the database is provided through either a WLAN without an Internet connection or through any Internet connection 90 assuming all actors are able to establish a connection (with Wi-Fi, 3/4G, or wired links). A mobile device 100 is preferred for remote on-the-field access of the server's database.

### Smart Node and Local Processing Unit Architecture Overview

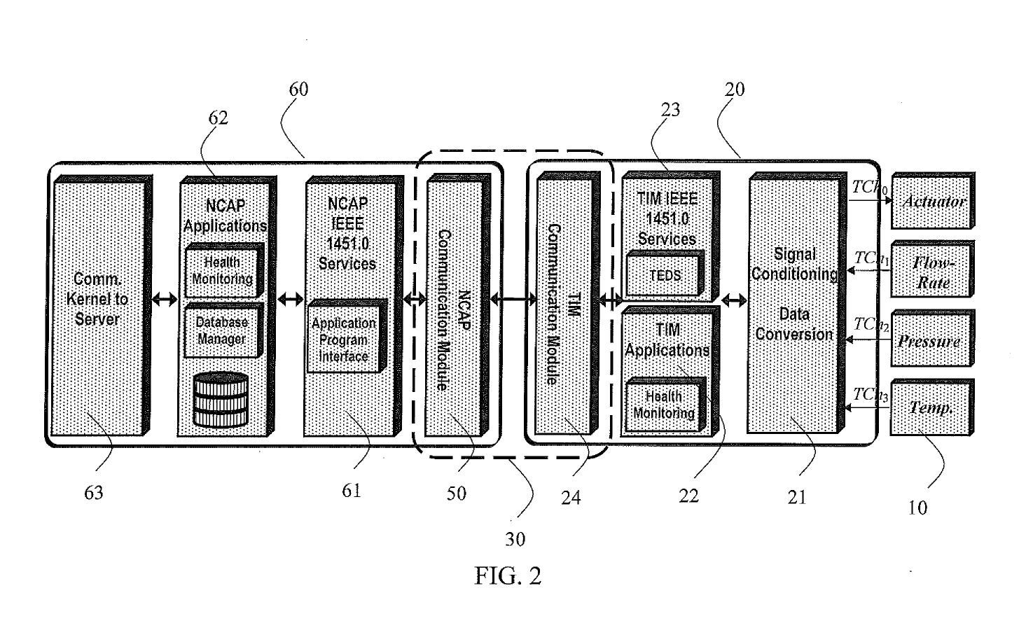

A more detailed outline of the architecture and components included within the smart nodes and local processing units is included in FIG. 2. Within the IEEE 1451.0 context, the smart nodes 20 are referred to as Transducer Interface Modules (TIM). Each TIM interfaces with one or more sensors or actuators 10 based on a Transducer Channel (referred to as TCh). The data to/from the transducers goes through a signal conditioning circuit 21 which performs any necessary operations on an analog signal such as adjusting offsets, filtering, and amplification. For the case of analog sensors, the smart node must include analog-to-digital (ADC) conversion, and for the case of analog actuators, digital-to-analog (DAC) conversion is necessary. The smart node then contains an embedded processor such as a microcontroller capable of TIM IEEE 1451.0 services 23 and custom TIM applications 22. TIM IEEE 1451.0 services include command execution and reply generation, sensor and actuator sampling/triggering, managing register states, and reading writing, updating, and storing Transducer Electronic Data Sheets (TEDS). Identification of the TIM and TCHs is conducted with an addressing format defined in the IEEE 1451.0 standard. TIM applications may include capabilities not defined in the standard such as digital signal processing, control, and Intelligent Software Element (ISE) execution (e.g. neural networks designed at the server level used for on-line processing). Interfacing with smart nodes requires an embedded communication module 24 which may be any physical wireless or wired medium. For plug and play capability, data packets are provided at the software layer in a standardized format according to IEEE 1451.0 and in a serial port profile. Then a communication module converts the packets to the desired protocol and medium, for instance, wireless ZigBee. The use of a serial port profile makes major software changes for accommodating different types of communication unnecessary.

An outline of the architecture and components of the local processing units 60, referred to as Network Capable Application Processors (NCAP) within the IEEE 1451.0 context is also provided in FIG. 2. Each NCAP interfaces with one or more smart nodes through a communication module 50 which must be compatible with those in the nodes. The module may either be embedded in the NCAP directly or connected over a wired link such as USB or RS-232. Each NCAP also interfaces to a central remote server based on the communication kernel to the server 63 which involves both software and hardware components. In this case, a wired link may be used based on RS-232 or Ethernet cables or alternatively, a wireless link employed based on an 802.11.x network with TCP/IP.

Control and management of the smart nodes is conducted with the IEEE 1451.0 services layer 61 through a standardized Application Programming Interface (API). The API is composed of four modules: (i) TransducerServices used by NCAP measurement and control applications to interact with the 1451.0 layer; (ii) ModuleCommunications for providing an interface between the standard and another IEEE 1451 family member and used for NCAP-TIM communications; (iii) Args which defines IEEE 1451.0 arguments; and (iv) Util with utility classes and interfaces for conversions. The NCAP can be defined as a portable dynamic or static library, where the files define methods that can be called with the API. Goals of the API are to: (1) satisfy the needs of IEEE 1451 NCAP and TIM systems; (2) simplify interactions by providing services for TIM discovery, Transducer access, Transducer management, and TEDS management; (3) accommodate IEEE 1451.X technologies; (4) accommodate a wide range of NCAP hardware platforms; (5) provide escape mechanisms; and (6) provide pass-through mechanisms.

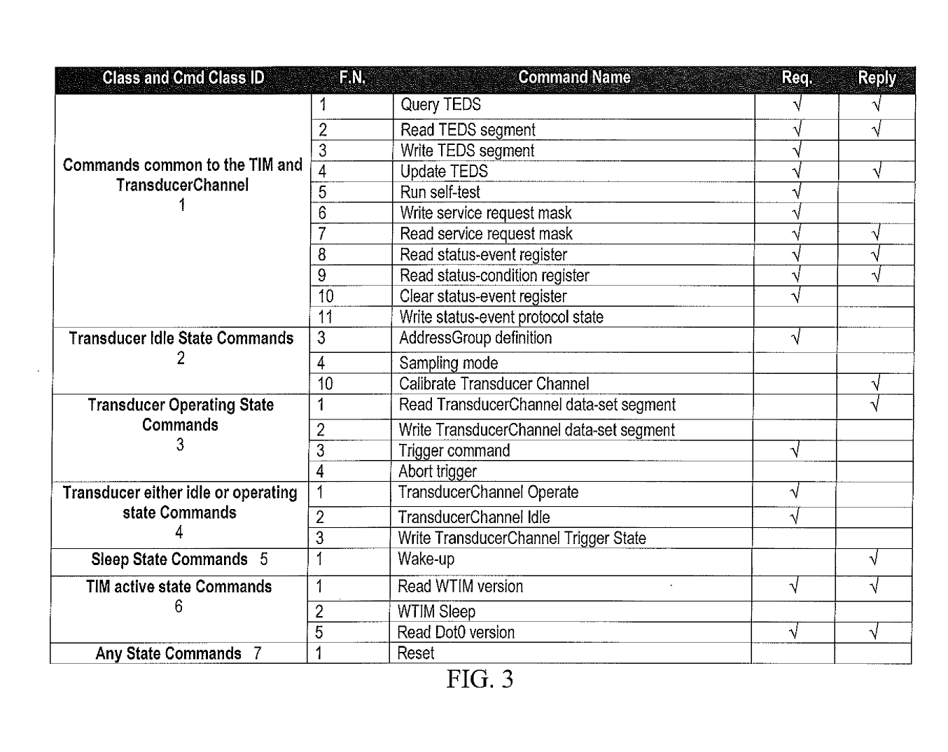

A set of standardized commands and replies as shown in FIG. 3 guide NCAP-TIM interaction. The commands are categorized according to a Class ID and a Function Number (F.N). Those commands that are required by the standard are indicated by the fourth column, and whether a reply is expected is denoted by the fifth column. The seven command classes are: (i) commands common to the TIM and TCh for managing TEDS, managing registers, running self-tests, and setting the status-event protocol state for enabling generation of TIM-initiated messages; (ii) transducer idle state commands for setting addresses, sampling modes, and performing calibration; (iii) transducer operating state commands for reading/writing data and performing triggering; (iv) transducer either idle or operating state commands for adjusting the TIM operating mode; (v) sleep state commands for sending wake-ups; (vi) TIM active state commands for obtaining the TIM and Dot0 versions and sending sleep commands; and (vii) any state commands for resets.

The local processing unit has custom applications 62 where capabilities include data processing based on TCh data (depends on the application, where examples include spectral analysis, wavelet analysis, etc.), ISE execution, and depending on the processing hardware and if the NCAP can be directly controlled by a user, an inference kernel for ISE design. With regards to data processing, the NCAP has the benefit of utilizing multi-sensor data, thus processing based on sensor correlations can be implemented. Finally, a small database is needed for organizing the processing results and configuration details.

### Local Processing Unit Detailed Operation

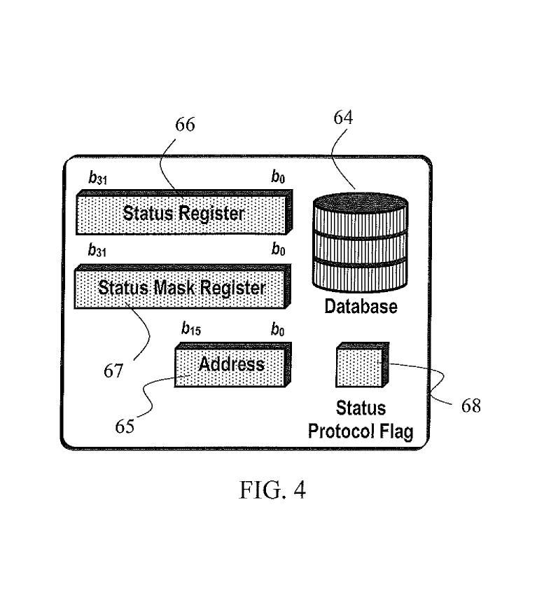

Each network has at least one local processing unit, referred to as the NCAP, that coordinates smart nodes, conducts system/subsystem data processing, and interfaces with the server. The NCAP can either be controlled directly by a user (with a graphical user interface) or run autonomously based on commands sent from the server. According to the monitored system, when certain data events occur (e.g. consider an environmental ocean monitoring system where an unexpected but statistically meaningful temperature rise is found), the local processing unit will transfer that information to the server based on the communication kernel 63 for near real-time status updates. For synchronizing the communication process, core components in each NCAP as illustrated in FIG. 4 are: (a) Local Database 64; (b) NCAP 16-bit Address Register 65; (c) NCAP 32-bit Status Register 66; (d) NCAP 32-bit Status Mask Register 67; and (e) Status Event Protocol Flag 68. These elements form what is referred to as the NCAP reduced reference model.

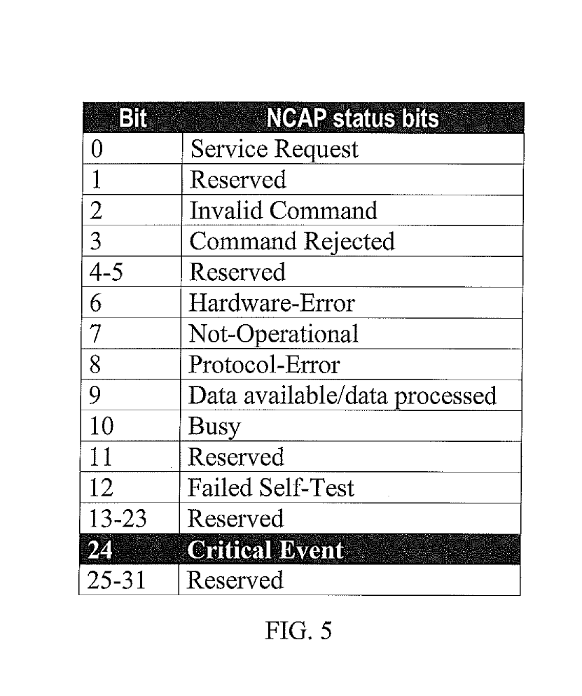

The NCAP 32-bit Status Register 66 allows tracking a set of conditions that can result after certain important events. Flags associated with command execution (Invalid Command and Command Rejected flags) enable determining when an error condition was generated during command execution. NCAP malfunction can be monitored through the Hardware Error, Failed Self-Test, and Not Operational flags. Communication errors activate the Protocol-Error and Busy flags. When a flag in the status register is set (i.e. a bit in the register is set equal to one) as a result of an NCAP event, the Service Request bit is set to indicate to the server of the situation which may require further attention. FIG. 5 lists the flags contained within the NCAP status register. It is also seen that the highlighted bit 24 is used for introducing a special condition not defined by the standard within the status register when an “event” is determined by the processing system. In this invention, an event is a meaningful occurrence in the processed data that is important to notify the rest of the system. What constitutes an event is defined a-priori by the user.

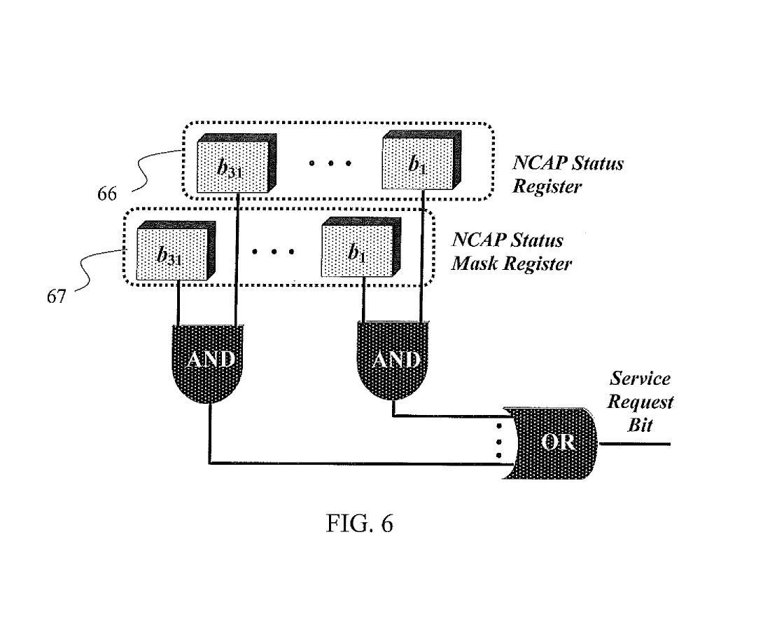

The NCAP Status Mask Register 67 enables selecting conditions that will be detected by the Service Request bit. The process is shown in FIG. 6 where each status register's n^{th}-bit is combined with the corresponding status mask register's n^{th}-bit by an AND logic. Having a value of one in the status mask register's bit forces that condition as an input to the OR logic that generates the Service Request Bit value (a zero in the bit forces the AND output to zero). Following this convention, only the bits specified by the mask register are used for updating the Service Request Bit status. By combining this functionality with the Status-Event Protocol State, the NCAP can make the server aware about a critical event that requires attention (hence, “service”). This results in an NCAP-initiated message to the server which forms the basis of an automated event awareness scheme (when an event is detected, it is forwarded to the server to update the database). It should be noted that the TIM contains analogous capability, so when an event is detected at the TIM, a notification is also sent to the server (the NCAP forwards the message). The choice of embedding processing algorithms and intelligent software elements in either the NCAP, or the TIM, or both, is a choice available to the user according to the application.

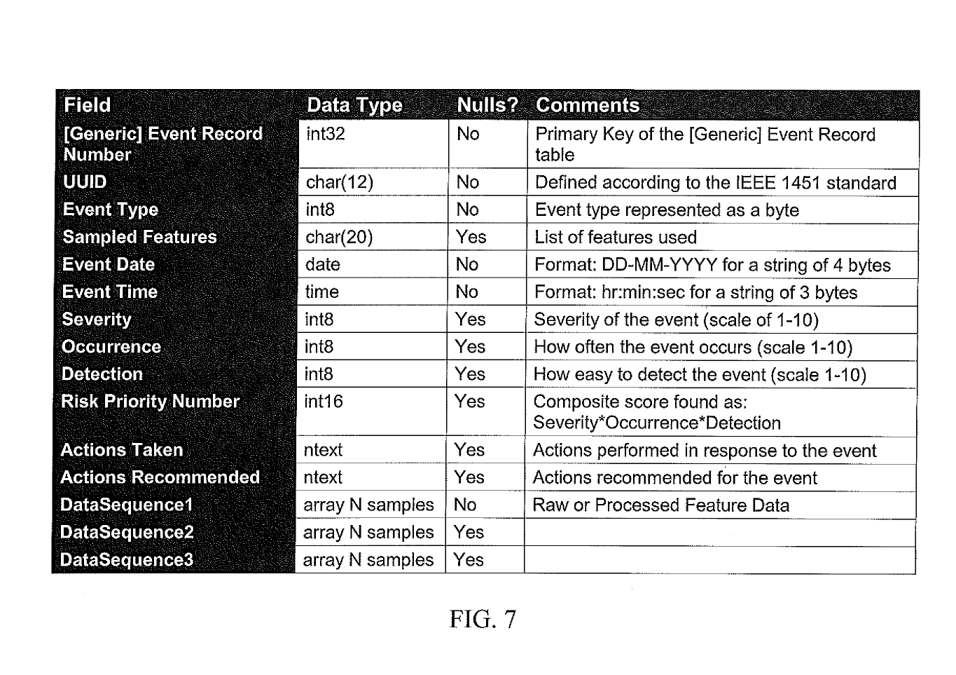

To record important event information, a local database 64 is used for storing processing result details in the local processing units. The fields that comprise an NCAP local database's table for a generic type of event are presented in FIG. 7. The user may create any number of tables according to the event types that are of interest. New entries in the local database can be generated dynamically when the NCAP is in the active state and the TIM (or NCAP) discover an event when processing data from transducers. The NCAP database manager will update a counter according to the number of table entries generated from the online discovery of events. By determining a record's counter value (via executing a Read Number of Records command), the server can assess when there is newly available event data to be read from the NCAP database (which requires executing a Read Event Record command) for automatically updating the server's database.

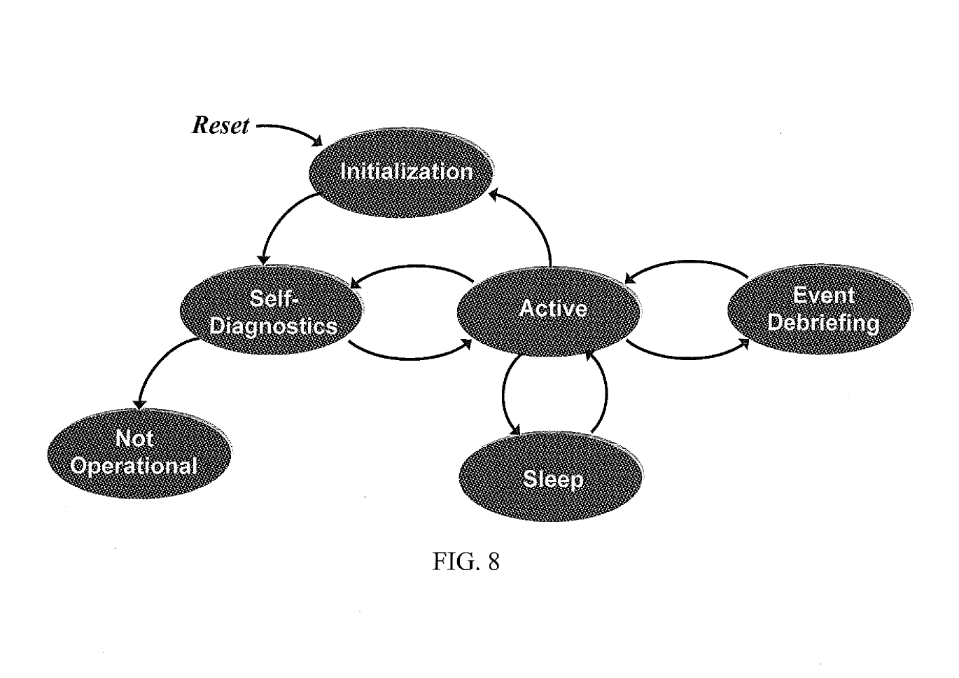

The NCAP operates according to the states in FIG. 8. After RESET, the NCAP moves to the INITIALIZATION state where input and output devices, control variables, and status registers are set to their default configurations. After INITIALIZATION, the NCAP goes to the SELF-DIAGNOSTICS state where a routine set is executed to verify proper operation of the NCAP modules. If damage is detected, then the NCAP transitions to the NOT-OPERATIONAL state (halt condition). Whether or not the NCAP is in the halt condition can be verified through the status register by testing the seventh bit (flag). While in the SELF-DIAGNOSTICS state, and after all the internal modules are verified to be operating properly, the NCAP then goes to the ACTIVE state where commands sent from the server (or clients) can be received and executed. While in the ACTIVE state, the NCAP can also perform data processing or control functions. Then, as controlled by commands, four transitions can occur as depicted in the figure: (a) moving back to the INITIALIZATION state (after receiving a Reset command); (b) transitioning to the SLEEP state (controlled by a Sleep command); (c) moving back to the SELF-DIAGNOSTICS state (to execute one or all of the NCAP diagnostic functions, as is also controlled by a command); and (d) moving to the EVENT DEBRIEFING state for transferring event data to the central server. The SLEEP state enables optimizing power consumption in the NCAP by only keeping the minimum number of modules operating while in this state. Transition from the SLEEP state to the ACTIVE state is controlled by the server (or clients) through a Wake-up command.

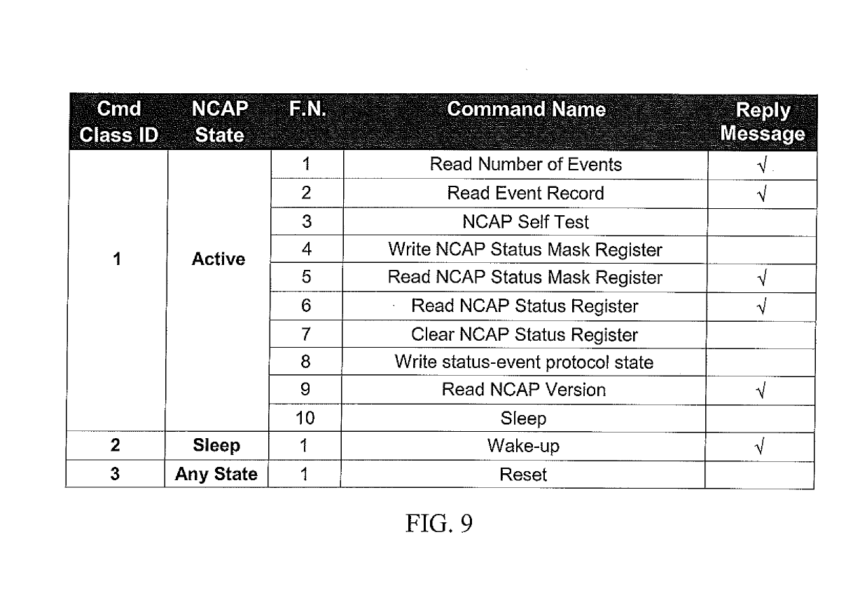

A set of twelve commands is used for managing the NCAP. These commands can be executed by the server through a suitable physical channel (e.g. serial, Ethernet, or 802.11.x wireless). The commands can also be executed by a remote client connected to the server whereby the messages are physically forwarded to the NCAP using the server. Referring to FIG. 9, the commands are grouped into three classes: (1) Active; (2) Sleep; and (3) Any State. Commands associated with the active state allow modifying the NCAP Status Mask Register (Write NCAP Status Mask Register and Read NCAP Status Mask Register), accessing the NCAP Status Register (Read NCAP Status Register and Clear NCAP Status Register), executing self-diagnostics (NCAP Self Test), enabling and disabling the Status-Event Protocol (Write Status-Event Protocol State), and accessing the NCAP Local Database (Read Event Record and Read Number of Records). Three commands: (i) Sleep; (ii) Wake-up; and (iii) Reset, are used to control transitions among the SLEEP, ACTIVE, and INITIALIZATION states respectively.

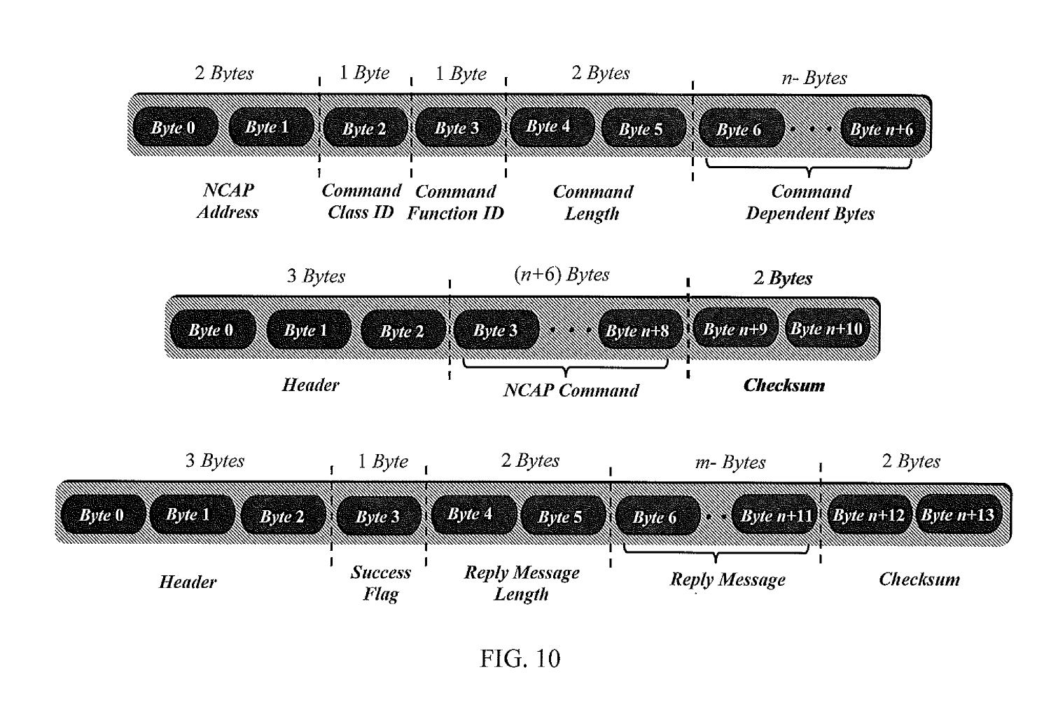

Referring to FIG. 10, there are two fields that identify the desired command to send from the server to an NCAP: (i) Command Class ID and (ii) Command Function ID. With these fields, commands are associated with the NCAP's operational state (where the Class ID corresponds to active, sleep, or any state as seen in FIG. 9) while also allowing for proper selection (with the Function ID as is also seen in FIG. 9). The format for each command is defined in FIG. 10 at the top layer, where in this format, the NCAP address enables selecting the destination device. The Command Class ID and Command Function ID are used for selecting the proper command and the Command Length field defines the number of additional bytes that are required. Then, the Command Dependent Bytes are uniquely formed according to the specific command. The entire data package format is defined in FIG. 10 at the middle, where in addition to the command bytes, a header is inserted for synchronization and a checksum for ensuring data integrity. For some cases the NCAP will respond with a reply message, therefore FIG. 10 at the bottom depicts the data package containing the reply message which is composed of the fields: (a) 3-byte header; (b) success flag; (c) reply message length; (d) reply message; and (e) checksum.

### Server and Client Architecture Overview

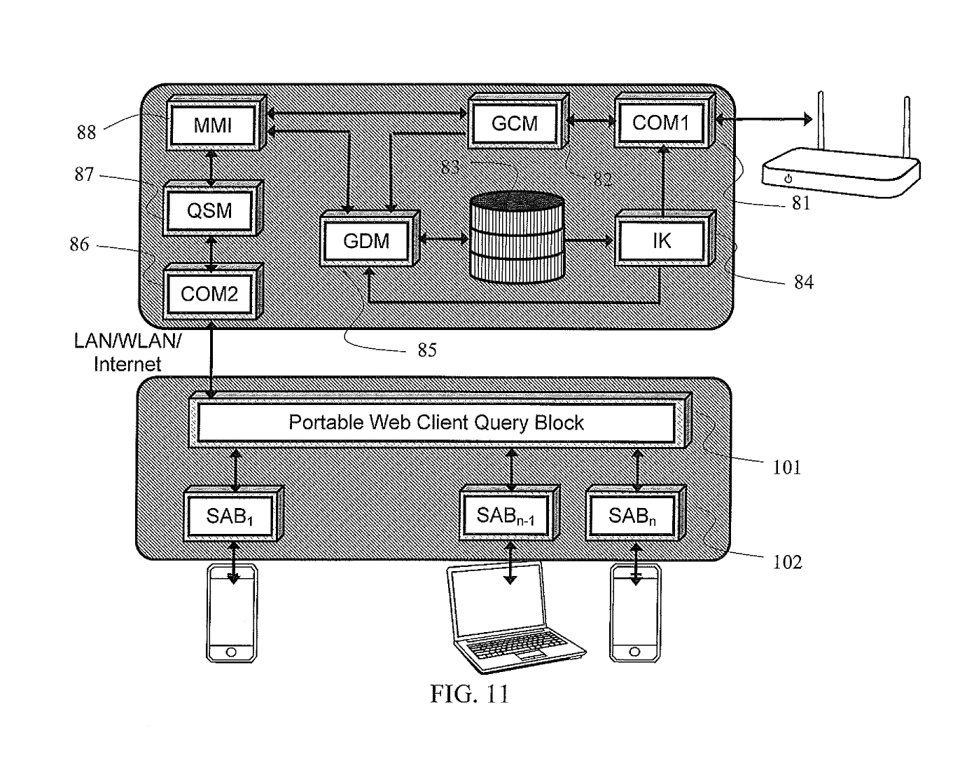

Referring to FIG. 11, the server is a computer with large processing and data storage capability and includes: (1) a customizable communication module (COM1) 81 (Wi-Fi, Ethernet, USB, etc.) for sending and receiving data to/from the local processing units; (2) a global communication manager (GCM) 82 for proper data stream parsing; (3) a database (DB) 83 to store sensor, event, and system configuration information, where a suitable representation is provided by the Sensor Model Language with XML convention; (4) an inference kernel (IK) 84 for designing and executing neural networks such as: Multilayer Perceptrons, Competitive Networks, Learning Vector Quantization Networks, Self-Organizing Maps, and so on, while also enabling pseudogenetic optimization; (5) a global database manager (GDM) 85 to process user data manipulations (from the MMI), sensor and low-level processed data (from the GCM), and high level processed results (from the IK) for correct data representation; (6) communication module (COM2) 86 for sending and receiving data to/from portable web clients; (7) query service module 87 (QSM) to handle inquiries from clients (from COM2) and provide data in XML format to the users; and (8) a man machine interface 88 (MMI) for interfacing with the server. This system can be expanded in terms of its features and also integrated with existing systems.

The web server application and portable web clients comprise the ubiquitous information system core. The software is based on a Web Service Oriented Architecture (SOA) and J2EE (Java 2 Enterprise Edition) environment consisting of a composite set of integration-aligned services that support a dynamically reconfigurable system-to-system process realization with an interface-based service description. Advantages of Web-based SOA include: (1) standard network protocols; (2) platform independence; (3) server-based component architectures; (4) flexibility; (5) scalability; and (6) distributed executions. Referring back to FIG. 1, users may collect data from the monitored system and then retrieve data from the server's database (managed by a web server application) through the Internet with appropriate authentication methods. Alternatively, an Internet connection is not necessary, provided that both the server and the clients are members of a local network (may be LAN or WLAN types). The portable web clients are thus able to interface with the server application, data processing and artificial intelligence tools, and information system. The clients can perform queries, data retrieval, and visualization without changes to the system. This is because the data processing system converts data into the XML standard format and utilizes Simple Object Access Protocol (SOAP) to call local objects to process data with specified functions, and then send data back to the application server or another remote subsystem. Four important functionalities in the web service network are: (1) XML; (2) Web Services Description Language (WSDL); (3) SOAP; and (4) Universal Description and Discovery of Information (UUID).

A unified method for implementing a client-server web service scheme provides a common procedure for handling queries to the server since the client software includes a query block 101 (which disregards the nature of the software and hardware platform) and software adapters 102 (SABₙ in a language such as Javascript) which drive content displaying processes in specific client platforms. The clients operate as origin of request objects and handler of response objects and the server is the origin of response objects and handler of request objects. The server and client web service architecture utilizes an application server that acts as the platform needed to implement information integration functionalities and data presentation services. The server can be accessed by various types of computing devices, provided that they have external communication ports and web application capability. For example, Android and iPhone are two very common types of smartphone technologies that may be readily used for realizing the clients.

Aspects of the portable web client software include data representation screen size, resolution, text boxes, viewport scaling, and the presented data. Considering the screen size, viewport elements are defined by adding a meta-information tag into the HTML file such that information about the webpage can be utilized for providing an optimal display. For example, a handler can be designed within the application to define parameters used during the content presentation. Considering sensor data transfer and query service attention, the Sensor Model Language (SML) and the Java Script Object Notation Remote Procedure Call Protocol (JSON-RPC) are used for starting a query and transferring data. In this way, a standardized method (complying with XML format) provides a portable system. JSON-RPC can be used over a wide range of message passing environments (e.g. sockets or http) where four base primitives: Stings, Numbers, Booleans, and Null, and two structures: Objects and Arrays, are utilized.

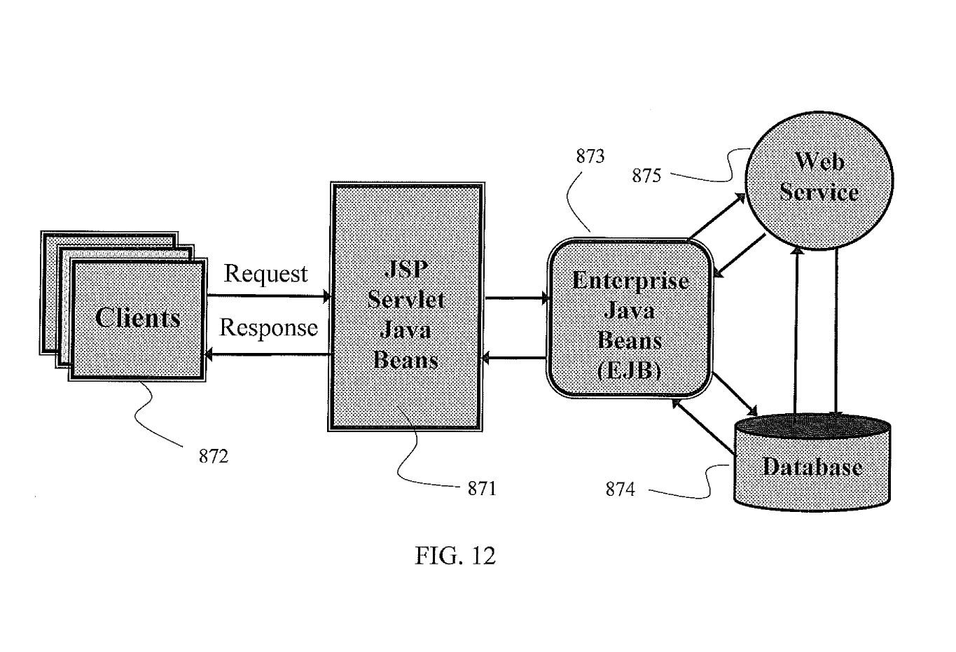

Attention to queries sent from the clients to the server (requesting information pertaining to configurations, electronic data sheets, data events, historical trends, etc.) is provided according to the architecture in FIG. 12, which shows the structure of the Query Service Module 87. The Java Service Page (JSP) 871 is responsible for the presentation layer which displays a friendly user interface to the clients 872 and forwards the requests to proper internal components based on processing logic. Servlet and Java Beans implement the data processing integration related tasks. Enterprise Java Beans (EJB) 873 executes all of the message forwarding, Web services, and database 874 access.

The Apache Axis Web Service 875 is then required to provide: (1) client-side APIs for dynamically invoking a SOAP web service; (2) a set of functions to translate WSDL documents into Java frameworks for consuming or supplying a web service; (3) mechanisms for hosting web services either within a servlet container or via a standalone server; (4) a framework that creates/composes message processing handlers into flexible and powerful processing chains; (5) data binding which enables mapping Java classes into XML schemes and vice versa; and (6) APIs for manipulating SOAP envelopes, bodies, and headers, and using them inside the message objects. The Apache Axis Web Service processes the received messages from clients by a chain mechanism, where the server first processes the message and looks for a transport chain, and if it is found, hands it to a MessageContext function. After the transport request processing completes without error, the Global chain function which contains handlers that process every message coming into the system, takes over. Afterwards, the server calls a service handler that performs the required functionality based on message content. Finally, the application objects are called at this point and return the query results.

Generally, remote access of data in the server is accomplished via the Web service framework just described. However, a direct link between portable web clients and the local processing units should also be made possible (for maximizing the system flexibility) by: (1) file sharing based on a secure ftp server over an Internet connection (requires that both devices are connected to the Internet); (2) Bluetooth link; and (3) smartphone Input/Output (I/O) connections (such as standard or micro USB). Also, the software (browsing processing) and devices can be easily upgraded in this framework.

### Distributed Intelligence Framework

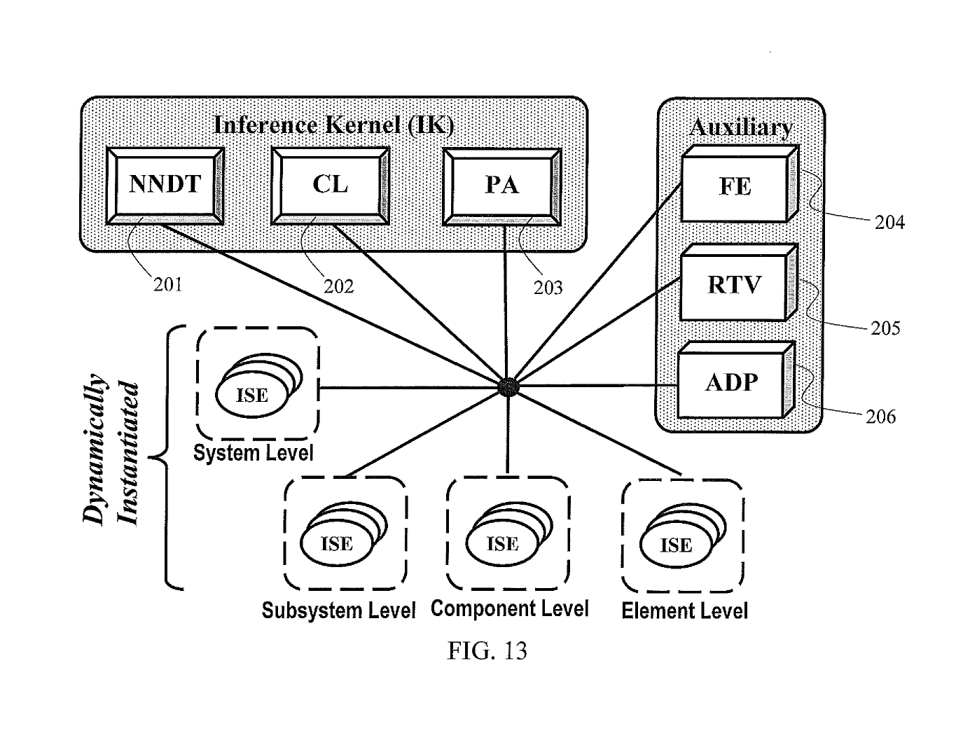

The enterprise data processing architecture provides a structure within which a distributed intelligence framework can be deployed. Referring to FIG. 13, a distributed intelligence framework includes an inference kernel with high level artificial intelligence software tools to design and deploy Intelligent Software Elements. The resulting ISEs (where an ISE belongs to a set of ANNₖ where k identifies the type of ANN) designed by the inference kernel can then be either executed locally or transferred to other platforms (such as the smart nodes) for distributed execution (at system, subsystem, and component levels). Such a process realizes a distributed computational platform, where intelligent processing capability can be transferred and embedded at the local sensor node level (for component level processing at the source) as well as at global levels (fusing sensor data).

Important features of this distributed intelligence framework include: (1) state-of-the-art inference based on neural networks, hybrid learning, collaborative learning, pseudogenetic optimization, and traditional network design paradigms; (2) customizable and distributed granularity in the system's intelligence enabled by networked intelligent software elements consisting of different types of ANNs; (3) distributed and standardized computational platform where the elements of the enterprise architecture (TIM, NCAP, server, clients) can serve as intelligent processing units and where the IEEE 1451.0 smart sensor standard facilitates integration into existing systems; and (4) real-time feature extraction libraries and user friendly interfaces for conducting the necessary data analysis and characterization steps to design and deploy the ISEs. Distinctive characteristics of the intelligence framework include the ability to accommodate: (i) dynamic and autonomous self-learning by collaborative learning; (ii) state-of-the-art fast learning algorithms; and (iii) optimization mechanisms by pseudogenetic algorithms.

Referring back to FIG. 13, the inference kernel contains three main blocks: (1) Neural Network Design Tools (NNDT) 201; (2) Collaborative Learning (CL) 202; and (3) Pseudogenetic Algorithms (PA) 203. These blocks are described as follows:

Neural Network Design Tools (NNDT). This provides the capability to design and train ANNs based on: (i) supervised learning where the Multilayer Perceptron (MLP) provides a suitable network type; (ii) unsupervised learning where Competitive Networks (CN) and Self-Organizing Maps (SOM) can both serve as baseline types; and (iii) hybrid learning based on Learning Vector Quantization (LVQ) networks. The main advantage of supervised learning is that it provides a way for working with a set of known conditions, whereas unsupervised learning enables recognizing new conditions based on underlying statistical differences (utilizing a clustering process) but is sensitive to the quality of input data, incomplete data, noise, and weak feature correlations. The resulting neural networks may be applied for various tasks related to pattern recognition or function approximation (classification, regression, clustering, etc.). The technology detailed in U.S. Pat. No. 8,510,234B2, “Embedded health monitoring system based upon Optimized Neuro Genetic Fast Estimator (ONGFE)” may be used to deploy the NNDT block.

Collaborative Learning (CL). A method to (a) transfer available knowledge to the unsupervised process; (b) autonomously define relations among subclasses, classes, and instantiations in the form of clusters from the unsupervised process; and (c) provide an engine with autonomous self-learning capability due to interaction with supervised and unsupervised schemes is addressed by this block. Collaborative learning involves the steps: (1) embedding knowledge by supervised learning; (2) performing unsupervised clustering; (3) transferring knowledge from “1” to the unsupervised system to optimize unsupervised learning and to define relations among clusters and classes (relating classes from supervised learning to clusters from unsupervised learning); and (4) operating in a collaborative fashion for blending both learning paradigms within a common generalized framework for autonomous system evolution. Steps “1” and “2” operate in parallel over the same domain with the difference being the nature of the learning algorithms. Step “3” categorizes a group of clusters (generated by an unsupervised trained network) that are actually subclasses of a class we are interested in. Hybrid learning based on LVQ acts as an interface between these two learning paradigms as it includes an input linear layer, a competitive layer (which is formed by copying over the trained CN), and an output linear layer (relating clusters to the supervised classes). Once instantiated, this scheme provides autonomous learning able to work with known and characterized conditions (from the supervised network) as well as a-priori unknown and newly emerging conditions (from the unsupervised network). The technology detailed in the patent US20130212049A1, “Machine Evolutionary Behavior by Embedded Collaborative Learning Engine (eCLE)” may be used to deploy the CL block.

Pseudogenetic Algorithms (PA). The last feature of the inference kernel is an optional optimization module using pseudogenetic algorithms. Optimization is started by generating a population of MLPs, and then converting neural network weights using an orthonormalization process and error prediction. A network performance index is then defined for estimating the effect of hidden neurons in the network. The neurons that optimize performance are kept for generating optimized networks. The ONGFE may be used for realizing this block as well as the scheme addressed by F. Maldonado in the PhD thesis entitled “Pseudogenetic algorithms for Multi-layer Perceptron design based upon the Schmidt Procedure”.

The inference engine capabilities are supported by a set of auxiliary blocks including: (i) preprocessing feature extraction (FE) 204; (ii) real time visualization (RTV) 205; and (iii) automated deployment process (ADP) 206. Each are described as follows:

Preprocessing Feature Extraction (FE). Neural network application requires the identification of meaningful patterns from the acquired sensor data, where characteristic parameters called features are obtained from preprocessing techniques. Ideally, a reduced set of features (comprising a relatively low dimensional vector) that are highly correlated with events of interest (e.g. in a health monitoring application, this would include healthy and faulty modes of operation) are input into the inference mechanism. Features can be computed using signal decomposition techniques, time and frequency domain statistics (e.g. mean, variance, root mean square, kurtosis, skewness, crest factor), spectral analysis techniques (e.g. linear prediction coefficients, reflection coefficients, line spectral pairs, etc.) and many others. The content of this block is defined according to the application, and success is measured based on the ISE performance in completing its assigned task. The feature extraction block should be included wherever ISEs are trained and executed (thus it would exist at both the high-level software elements such as the server as well as the distributed elements such as the smart nodes).

Real-Time Visualization (RTV). The ability for a user to analyze signals of interest based on numerical data, streaming plots, etc. should be provided by the overall architecture. This greatly facilitates the manual neural network design process and the selection and optimization of features. Additionally, automated feature analysis such as feature selection mechanisms (wrapper type techniques, etc.) can be included to reduce the user workload in the design process. Unlike the case with the FE block, visualization would typically only be needed at the processing unit used for training the ISEs (such as the server). However, there are no specific requirements defined with this respect.

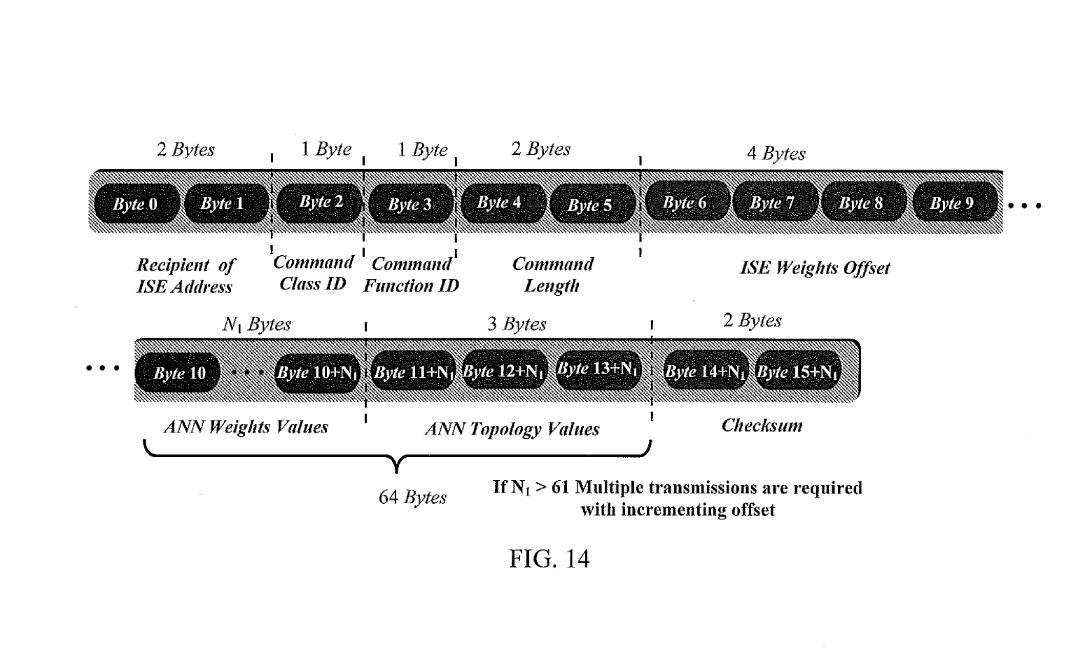

Automated Deployment Process (ADP). A core innovation of the disclosed technology is the ability to transmit ISEs over physical communication media based on the use of a software stack from the IEEE 1451.0 smart sensor standard. Specifically, neural network topology definition and weights can be packaged into an IEEE 1451.0 augmented WriteTransducerChannel data-set segment command (referring to FIG. 3) and transferred to the distributed processing units. As illustrated with FIG. 14, the complete command includes the fields: (1) address (2-bytes) of the intended recipient of the ISE; (2) command class ID (1-byte) equal to 3; (3) function number (1 byte) equal to 2; (3) command length (2-bytes) depending on the ANN size; (4) offset value (4 bytes) that is incremented each time the command is sent to load the weights into the proper memory locations (may be necessary depending on the size of the network based on how many weights values are involved); (5) weights data (64 bytes) which, for a supervised network case such as an MLP would consist of: (i) input to hidden unit weight matrix wₜₕ, (ii) threshold vector tₕ, (iii) output weight matrix wₒ, and (iv) network topology data such as the number of input neurons N, hidden neurons Nₕ, and output neurons M; and (6) checksum (2 bytes) for data verification. The ability to physically transmit ISEs using this standardized framework is a significant aspect of this invention as it readily enables for the instantiation of distributed intelligence for large processing applications.

### Data Processing Server Database

The preferred embodiment of the present invention contains an information system (IS) residing at the server side integrating three main functionalities: (1) relational database composed of a set of tables; (2) query system; and (3) database manager. With regard to the database, five core information types are needed for providing full support to data processing and configuration management activities. First, information related to the facilities employing the present invention must be included. Second, information pertaining to the various users shall be contained within the database to support system management, access control, security with authentication, and defining privileges to the system features. Third, the specifications and depot information of entities (e.g. sensors, actuators, platforms, etc.) relevant to the system should be included. Fourth, manufacturer specifications and datasheets related to transducers (sensors and actuators) utilized by the data processing system shall be stored. Fifth, critical event related information shall be tracked by the database including: (a) event registration data (part ID, event type, event date and time, etc.); (b) event analysis information (event effects and causes, actions recommended and taken, etc.); and (c) recorded signal sequences (both raw sensor data and derived feature data) that were used during the event detection.

The primary purpose of the database is to enable registering important events in a monitored system for facilitating automated analysis of large datasets. A graphical user interface installed in the server provides direct user access, although remote access through clients is also possible based on the Apache server. A critical capability of the database is to allow for the automation of event registration. This means that once an event (which is defined a-priori by the user) is detected by the system, this knowledge is transferred to the server (utilizing the IEEE 1451.0 status event protocol state method) for performing an update operation without any intervention required on the part of the user. It is thus possible that event information, when detected at the sensor node level, can go from the TIM, to the NCAP, server, all the way to the client in a fully autonomous way.

When constructing the database it is required to define the primary keys (PK) which uniquely identify each record in the associated table. In addition, foreign keys must be listed, which are data columns that point to the PK in another table. These keys can be used in two types of constraints to preserve data integrity: (1) internal foreign key constraints where the affected field is a column in the current table that points towards a primary key in the source table and (2) primary key as foreign key constraints where the affected field contains the primary key of the current table. The main goal of these constraints is to ensure that data is updated in a consistent way across a set of interrelated tables. These constraints may be external or internal from the current table. Other types of constraints are used to limit the range of data values (e.g. birthdate less than currentdate).

Queries enable a user to access information from the database in an efficient way and make possible managing relations among processed data for further analysis. A query creates a view, which is a virtual table that acts as a predefined query and can be referenced as if it were a table. Examples of queries include: (i) what sensors detected a given event; (ii) what is the most common event type; (iii) what events occurred within a given period of time; (iv) what is the effect of a given event; (v) how long did a certain event occur for, etc. Many other queries can be easily defined according to the particular user's needs. Moreover, the events are defined according to the user's application and may be certain environmental conditions, faulty operation of a mechanical system that is being monitored, high-risk targets identified in a surveillance application, and many others.

### Features of the Present Invention

The features of the present invention are summarized as follows:

1. An enterprise data processing architecture allows for the deployment of data processing and intelligent software elements in large and distributed applications based on smart and wireless technologies. The main actors in the architecture include: smart sensor/actuator nodes, local processing units, a centralized server, and sets of clients.

2. The smart sensor/actuator nodes, acting as TIMs in the IEEE 1451.0 context, interface with one or more transducers for data acquisition or control, contain embedded processing for command execution, local data processing, and the storing of Transducer Electronic Data Sheets (TEDS), and have communication modules.

3. The local processing units, acting as NCAPs in the IEEE 1451.0 context, then interface with networks of smart sensor nodes (at the low level) and a server (at the high level) based on wired and/or wireless communications, and contain capability for command execution and embedded data processing, include local databases, and enable integration into custom applications based on a standardized API.

4. The server interfaces with a local processing unit and sets of remote clients and contains a graphical user interface for user interaction with the data processing system, and a relational database for storing relevant data that can be updated by the NCAP (based on automated event messages), local user, or remote clients.

5. The sets of clients, which may be any type of computational platform with web application access, but are typically mobile devices such as smartphones, tablets, or laptops, then interact with the server based on a local wireless connection or remotely via an Internet portal for viewing and managing the status of the data processing system.

6. A distributed intelligence framework where intelligent software elements may be designed in platforms (such as the server) with sufficient processing capability and transferred to distributed computational platforms (such as the smart nodes) for local execution of the learned functions (such as pattern recognition, functional mapping, etc.).

One skilled in the art will understand that the embodiment of the present invention as shown in the drawings and discussed above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles.

What is claimed is:

1. A distributed data processing system comprising:
a plurality of a first type of processing units, each interfacing with one or more transducers to perform data acquisition or control as well as local data processing;
one or more second type of processing units that interface with both said first type of processing units and a server based on wired or wireless communication modules, and that also provide data processing;
a server that interfaces with both the said second type of processing units and clients consisting of a database for storing relevant data pertaining to the application at hand and which can be manually updated by either local users or clients as well as automatically updated by the second type of processing units; and
one or more clients which may be any type of computational platform with web application access and that can interact with the server based on a local data network or remotely via an Internet connection.

2. The system, as recited in claim 1, wherein said first type of processing units contain either analog-to-digital conversion for analog sensors or digital-to-analog conversion for analog actuators, signal conditioning circuits, a microprocessor with embedded software, and a communication module.

3. The system, as recited in claim 1, wherein said first type of processing units act as Transducer Interface Modules (TIMs) that are able to execute commands received from the second type of processing units and with memory for storing Transducer Electronic Data Sheets (TEDS).

4. The system, as recited in claim 1, wherein said second type of processing units comprise:
a microprocessor or computer with software for providing actuator control and/or sensor data processing;
a local database for storing information associated with the sensor and/or actuator network;
a first communication module for interacting with the first type of processing units;
a second communication module for interacting with the server; and
an optional third communication module for directly interacting with clients.

5. The system, as recited in claim 4, wherein the said local database can have new entries added dynamically when new events are found while processing data from transducers, where an event is defined as a statistically meaningful occurrence in the data.

6. The system, as recited in claim 1, wherein said second type of processing units act as Network Capable Application Processors (NCAP) able to execute commands received from the server and send commands to the first type of processing units.

7. The system, as recited in claim 6, wherein said NCAPs operate in one of the following states: (i) initialization; (ii) self-diagnostics; (iii) not-operational when damage is detected in the unit; (iv) active when processing sensor data or actuator commands; (v) sleep when in a low power mode; and (vi) event debriefing when transmitting data to the server.

8. The system, as recited in claim 6, wherein said NCAPs can autonomously initiate the transmission of a messages to the server or clients when special conditions are detected, wherein said special conditions are defined according to the application at hand.

9. The system, as recited in claim 6, wherein said NCAPs further provide control and management of said first type of processing units based on an IEEE 1451 services layer with an Application Programming Interface (API).

10. The system, as recited in claim 9, wherein said IEEE 1451 services include command execution and reply generation, sensor and actuator sampling and triggering, managing register states, and reading, writing, and updating Transducer Electronic Data Sheets.

11. The system, as recited in claim 9, wherein said API is composed of four modules for: (i) NCAP measurement and control applications to interact with the IEEE 1451.0 layer; (ii) providing an interface between the standard and another IEEE 1451 family member; (iii) defining IEEE 1451.0 arguments; and (iv) defining utility classes and conversions.

12. The system, as recited in claim 6, wherein core software components of said NCAPs are a local database, status register, status mask register, and status event protocol flag.

13. The system, as recited in claim 1, wherein said server is a computer with large data processing and storage capability comprising:
a first communication module for interacting with the second type of processing units;
a communication manager for proper data stream parsing and decodification;
a database containing data related to the data processing application at hand;
a database manager for updating the database from manual user manipulations or from data that is automatically received from the second type of processing units;
a second communication module for interacting with remote clients;
a query service module to handle inquiries from clients; and
graphical user interface.

14. The system, as recited in claim 1, wherein said server's database contains information related to facilities employing the system, users accessing the system, specifications and depot information of hardware entities relevant to the system, manufacturer data of hardware entities relevant to the system, and system event data.

15. The system, as recited in claim 1, wherein said clients are mobile hand devices with limited processing capabilities such as smartphones, PDAs, tablets, or laptops.

16. The system, as recited in claim 1, further comprising a client-server web service scheme wherein clients operate as origin of request objects and handler of response objects and the server as the origin of response objects and handler of request objects.

17. The system, as recited in claim 16, wherein said clients can perform queries, data retrieval, and visualization without making changes to the system.

18. The system, as recited in claim 17, wherein said queries enable accessing information from the database in an efficient way by creating a view that extracts only relevant data from the database pertinent to answering a given question.

19. The system, as recited in claim 16, wherein the said web service provides: (1) client-side APIs for dynamically invoking a web service; (2) functions to translate documents for consuming or supplying a web service; (3) mechanisms for hosting web services within a servlet container or standalone server; (4) a framework that creates/composes message processing handlers; (5) data binding functions; and (6) APIs for manipulating envelopes, bodies, and headers, and using them inside the message objects.

20. A distributed intelligence system comprising:
one or more processing units that are capable of designing artificial neural networks for use in classification tasks;
one or more processing units containing the designed neural networks to process input data for on-line classification; and
a data link which enables the transfer of artificial neural networks from the processing units used for designing to the processing units used for on-line classification processing.

21. The system, as recited in claim 20, wherein said processing units for both designing artificial neural networks as well as on-line classification processing include feature extraction whereby statistically meaningful patterns are extracted from acquired sensor data prior to input into the artificial neural networks.

22. The system, as recited in claim 20, wherein the IEEE 1451 Write TransducerChannel data-set segment command provides a standardized format for transferring the designed artificial neural network weights and parameters.

23. The system, as recited in claim 20, wherein a graphical visualization system enables a user to analyze signals of interest based on numerical data displays and updating plots.

24. The system, as recited in claim 20, wherein said processing units capable of designing artificial neural networks also contain a Collaborative Leaning method with supervised, unsupervised and hybrid learning capability that: (a) transfers available knowledge to the unsupervised process; (b) autonomously defines relations among classes associated with a supervised process to clusters associated with an unsupervised process; and (c) provides autonomous self-learning due to interaction with supervised and unsupervised schemes.

25. The system, as recited in claim 20, wherein said processing units capable of designing artificial neural networks also contain pseudogenetic algorithms which enable optimizing artificial neural network performance based on a process with orthonormalization, error prediction, and estimation of the effect of hidden neurons in the network.
